(19) United States
(12) Patent Application Publication
(10) Pub. No.: US 2017/0268951 A1
(43) Pub. Date: Sep. 21, 2017

(54) THERMAL TYPE VACUUM GAUGE

(71) Applicant: NATIONAL KAOHSIUNG UNIVERSITY OF APPLIED SCIENCES, Kaohsiung City (TW)

(72) Inventors: Chung-Nan Chen, New Taipei City (TW); Chih-Chun Chen, Taichung City (TW)

(21) Appl. No.: 15/070,276

(22) Filed: Mar. 15, 2016

(51) Int. Cl. G01L 21/12

(52) U.S. Cl. CPC G01L 21/12

(57) ABSTRACT

A thermal type vacuum gauge is disclosed herein and includes a first floating structure, a second floating structure, a first cavity and a second cavity. The first floating structure is formed by the first insulating layer, the second insulating layer, and the first sensing resistor. The second floating structure is formed by the second insulating layer, and the second sensing resistor. The first cavity and the second cavity are respectively formed below the first floating structure and the second floating structure. The thermal type vacuum gauge is implemented in a measurement circuit having a first resistor, a second resistor, a third resistor and a fourth resistor. The first sensing resistor and the second sensing resistor are respectively implemented to be as at least two of the first resistor, the second resistor, the third resistor and the fourth resistor of the measurement circuit.

### BACKGROUND OF THE INVENTION

1. Field of the Invention

The present invention relates to a thermal type vacuum gauge, and more particularly relates to a thermal type vacuum gauge with a wider effective pressure dynamic range.

2. Description of Related Art

Sensing method of a thermal type vacuum gauge is to implement a mechanism that gas thermal conduction of internal components within the sensor is changed in accordance with variation of gas pressure to perform gas pressure detection. When the gas thermal conduction is changed, the temperature of the components is also changed so as to vary physical characteristics of the sensing component.

If the heat generated by the sensing component of the thermal type vacuum gauge is very easy to be expelled, the temperature of the sensing component will not be increased efficiently. A sensing result of the thermal type vacuum gauge will be affected. Therefore, the thermal conductivity sensor usually includes a floating structure to prevent heat from being expelled. When a current flows through the sensing component, the heat generated by the sensing component is not easy to spread via thermal conduction pathways. Therefore, the temperature of the sensing component is effectively increased. FIG. 9 is a sectional view of a conventional thermal type vacuum gauge. As shown in FIG. 9, the conventional thermal type vacuum gauge 80 includes a sensing resistor 81, a semiconductor substrate 82, and an insulating layer 86. A cavity 83 is formed in the semiconductor substrate 82, and the sensing resistor 81 and the insulating layer 86 are disposed above the cavity 83. A contact portion between the insulating layer 86 and the semiconductor substrate 82 is used as a supporting structure and two ends of the sensing resistor 81 extend to the semiconductor substrate 82. Therefore, main thermal pathways of the sensing resistor 81 include solid thermal conduction pathway 84 and gas thermal conduction pathway 85. The solid thermal conduction pathway 84 is to transfer the heat generated by the electrified sensing resistor 81 via the insulating layer 86 to the semiconductor substrate 82. The gas thermal conduction pathway 85 is to implement gas molecules bumping to each other at a space between the semiconductor substrate 82 and the sensing resistor 81 to conduct heat. In a pressure dynamic range, the gas thermal conduction is increased in accordance with a number of the molecules, and a number of the gas molecules are proportional to the gas pressure. Therefore, when the gas pressure is changed, the gas thermal conduction is changed so as to vary the temperature of the sensing resistor 81 and affect a resistant value of the sensing resistor 81. Since a good heat isolating result exists between the conventional sensing resistor 81 and the semiconductor substrate 82, the thermal conduction effect of the solid thermal conduction pathway 84 is worse than the thermal conduction effect of the gas thermal conduction pathway 85 under constant pressure.

Accordingly, the thermal conduction of the thermal type vacuum gauge will affect the sensing efficiency of the sensing component so as to affect the pressure dynamic range of the pressure sensor. Significant parameters affecting the pressure dynamic range include a pressure upper limit and a pressure lower limit The description of the pressure upper limit and the pressure lower limit is disclosed in the following.

1. The pressure lower limit is determined by the solid thermal conduction. In a normal atmosphere pressure, a principle thermal conduction mechanism is gas thermal conduction. When the pressure drops, the effect of the gas thermal conduction becomes smaller, and the temperature of the sensing component becomes more difficulty to be expelled in accordance with the gas thermal conduction. When the pressure drops till the effect of the gas thermal conduction is less than the effect of the solid thermal conduction, the sensing component is thermally and mainly conducted by the solid thermal conduction. Therefore, the temperature variation of the sensing component is very slight, and the pressure lower limit is determined by the solid thermal conduction of the sensing component.

2. The pressure upper limit is determined by an interval between the sensing component and the semiconductor substrate. The mechanisms of the gas thermal conduction are classified into: A. The gas average free path is shorter than the interval between the sensing component and the semiconductor substrate. B. The gas average free path is greater than or close to the interval between the sensing component and the semiconductor substrate. Since the gas average free path is inversely proportional to the pressure, the gas average free path is increased when the pressure is decreased. Therefore, when the average free path of the gas is greater than or close to the interval between the sensing component and the semiconductor substrate, the effect of the gas thermal conduction is directly proportional to the pressure. When the pressure is increased and the average free path of the gas becomes shorter, the thermal conduction of the gas is irrelative to the pressure if the average free path of the gas is shorter than the interval between the sensing component and the semiconductor substrate. Accordingly, the interval between the sensing component and the semiconductor substrate is a factor to affect the pressure upper limit.

FIG. 10A is a schematic view of a conventional thermal type vacuum gauge 90A. As shown in FIG. 10A, the conventional thermal type vacuum gauge 90A includes a sensing component 91A and a semiconductor substrate 92A. A cavity 93A with an upper opening is formed between the sensing component 91A and the semiconductor material 92A. A floating structure 94A is formed above the cavity 93A and the sensing component 91A is disposed on the floating structure 94A. Through this design, supporting arms 95 of the floating structure 94A are configured to perform the solid thermal conduction, so the solid pathway for conducting the heat from the sensing component 91A to the semiconductor substrate 92A is reduced. Since the contact area between the sensing component 91A and the semiconductor substrate 92A is decreased, the cavity 93A formed within the semiconductor substrate 92A will make the heat not easy to conduct to the semiconductor substrate 92A. Since the conduction of the heat caused by the solid thermal conduction is decreased, the pressure lower limit can be reached to be a lower pressure lower limit However, since the space of the cavity 93A between the sensing component 91A and the semiconductor substrate 92A is larger, the pressure upper limit is lower because of the effect of the gas thermal conduction.

With reference to FIG. 10B, FIG. 10B is a schematic view of another conventional thermal type vacuum gauge 90B. The conventional thermal type vacuum gauge 90B includes a sensing component 91B and a semiconductor substrate 92B. It is obvious to be seen in FIG. 10B, by comparing to FIG. 10A, that a connecting portion 93B between the sensing component 91B and the semiconductor material 92B includes a larger area, so the effect of the solid thermal conduction is larger. However, since the space 94B between the sensing component 91B and the semiconductor substrate 92B is smaller, the pressure lower limit of the thermal conductivity sensor 90B is a higher pressure lower limit FIG. 11 is a curved diagram of a relationship between the thermal type vacuum gauges in FIG. 10A and FIG. 10B. It is obvious to be seen in FIG. 11 that the thermal type vacuum gauge 90A in FIG. 10A includes a lower pressure lower limit and a lower pressure upper limit and the thermal type vacuum gauge 90B in FIG. 10B includes a higher pressure upper limit and a higher pressure lower limit

Accordingly, a need arises to design a thermal type vacuum gauge including a higher pressure upper limit and a lower pressure lower limit, so the thermal type vacuum gauge includes a wider and effective pressure dynamic range.

### SUMMARY OF THE INVENTION

An objective of the present invention is to provide a thermal type vacuum gauge and the thermal type vacuum gauge includes a wider effective pressure dynamic range.

According to the aforementioned objective, a thermal type vacuum gauge has a substrate, a first insulating layer formed on the substrate, a second insulating layer formed on the first insulating layer, at least one first sensing resistor formed above the first insulating layer, at least one second sensing resistor formed above the first insulating layer and separated from the at least one first sensing resistor, and a plurality of etching holes formed around the at least one first sensing resistor and the at least one second sensing resistor, and the thermal type vacuum gauge comprises a first floating structure, a second floating structure, a first cavity and a second cavity. The first floating structure is formed by the first insulating layer, the second insulating layer, and the at least one first sensing resistor. The second floating structure is formed by the second insulating layer and the at least one second sensing resistor. The first cavity and the second cavity respectively are formed below the first floating structure and the second floating structure, wherein a depth of the first cavity is different from the second cavity thereof The thermal type vacuum gauge is implemented in a measurement circuit having a first resistor, a second resistor, a third resistor and a fourth resistor, and the at least one first sensing resistor and the at least one second sensing resistor are respectively implemented to be as at least two of the first resistor, the second resistor, the third resistor and the fourth resistor of the measurement circuit.

Another objective of the present invention is to provide a thermal type vacuum gauge with wider pressure dynamic range than the conventional thermal type vacuum gauge.

According to the aforementioned objective, a thermal type vacuum gauge has a substrate, a first insulating layer formed on the substrate, a second insulating layer formed on the first insulating layer, at least one first sensing resistor formed above the first insulating layer, at least one second sensing resistor formed above the first insulating layer and separated from the at least one first sensing resistor, and a plurality of etching holes formed around the at least one first sensing resistor and the at least one second sensing resistor. The thermal type vacuum gauge includes a first floating structure, a second floating structure, a first cavity, a second cavity, a passivation layer and a plurality of electrical connecting wires. The first floating structure is formed by the first insulating layer, the second insulating layer, and the at least one first sensing resistor. The second floating structure is formed by the second insulating layer and the at least one second sensing resistor. The first cavity and the second cavity are respectively formed below the first floating structure and the second floating structure, wherein a depth of the first cavity is different from the second cavity thereof The passivation layer is formed above the at least one second sensing resistor and the second insulating layer. The electrical connecting wires are formed above the second insulating layer and below the passivation layer. The thermal type vacuum gauge is implemented in a measurement circuit having a first resistor, a second resistor, a third resistor and a fourth resistor, and the at least one first sensing resistor and the at least one second sensing resistor are respectively implemented to be as at least two of the first resistor, the second resistor, the third resistor and the fourth resistor of the measurement circuit.

The thermal type vacuum gauge in the present invention includes a higher pressure upper limit and a lower pressure lower limit, so the thermal type vacuum gauge includes a wider and effective pressure dynamic range.

### BRIEF DESCRIPTION OF THE DRAWINGS

FIG. 1A is a top view of a thermal type vacuum gauge in the present invention;

FIG. 1B is a sectional view of the thermal type vacuum gauge in FIG. 1A;

FIG. 1C is a sectional view of the thermal type vacuum gauge in another embodiment of the present invention;

FIG. 2 is a flow chart of a method to manufacture the thermal type vacuum gauge in the embodiment of the present invention;

FIG. 3A-FIG. 3G are schematic views of process procedures of the thermal type vacuum gauge in the present invention;

FIG. 4 is a flow chart of a method to manufacture the thermal type vacuum gauge in another embodiment of the present invention;

FIG. 5A-FIG. 5G are schematic views of process procedures of the thermal type vacuum gauge in another embodiment of the present invention;

FIG. 6A and FIG. 6B are measurement circuit diagrams implemented in the thermal sensing device in FIG. 1A and FIG. 1B;

FIG. 7A-FIG. 7D are measurement circuit diagrams implemented in the thermal sensing device in FIG. 1A and FIG. 1B;

FIG. 8 is a characteristic curve diagram of the thermal type vacuum gauge in the present invention and the conventional thermal type vacuum gauge;

FIG. 9 is a schematic view of the conventional thermal type vacuum gauge;

FIG. 10A and FIG. 10B are schematic views of the conventional thermal type vacuum gauges; and

FIG. 11 is a characteristic curve diagram of the conventional pressure sensor.

### DETAILED DESCRIPTION OF THE PREFERRED EMBODIMENT

These and other aspects of the embodiments herein will be better appreciated and understood when considered in conjunction with the following description and the accompanying drawings.

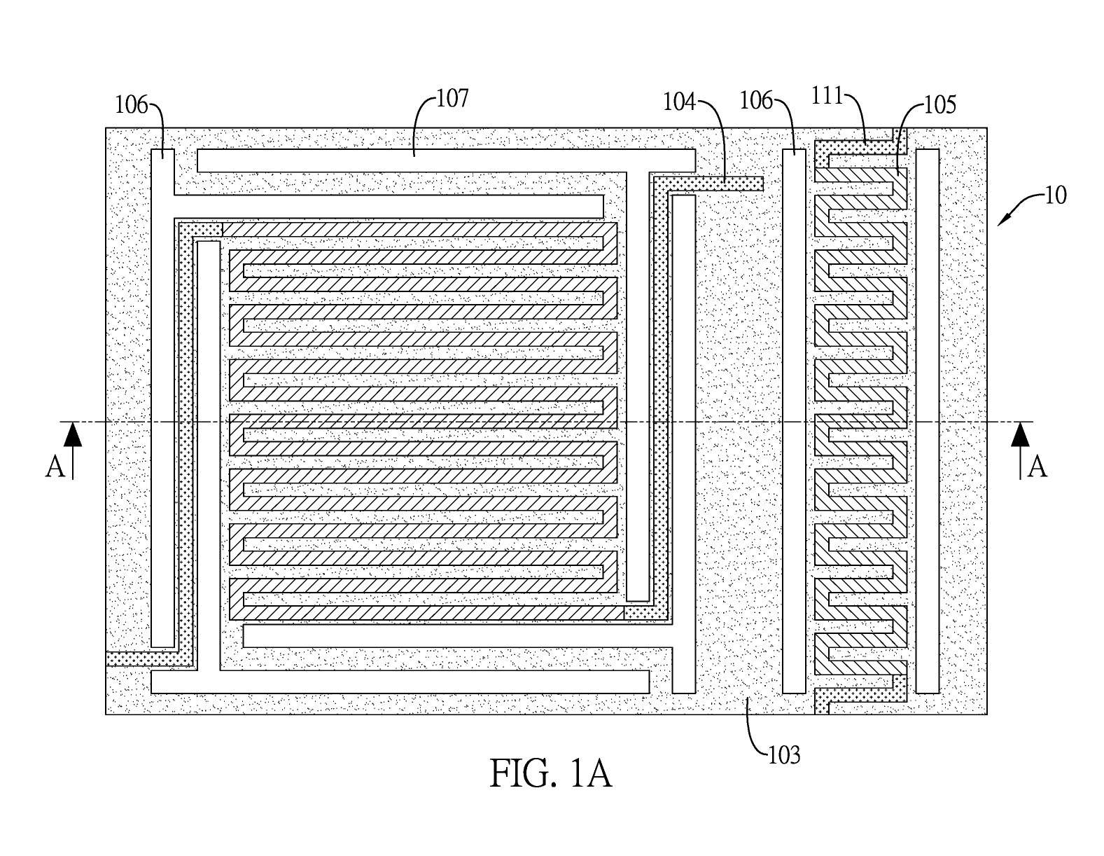

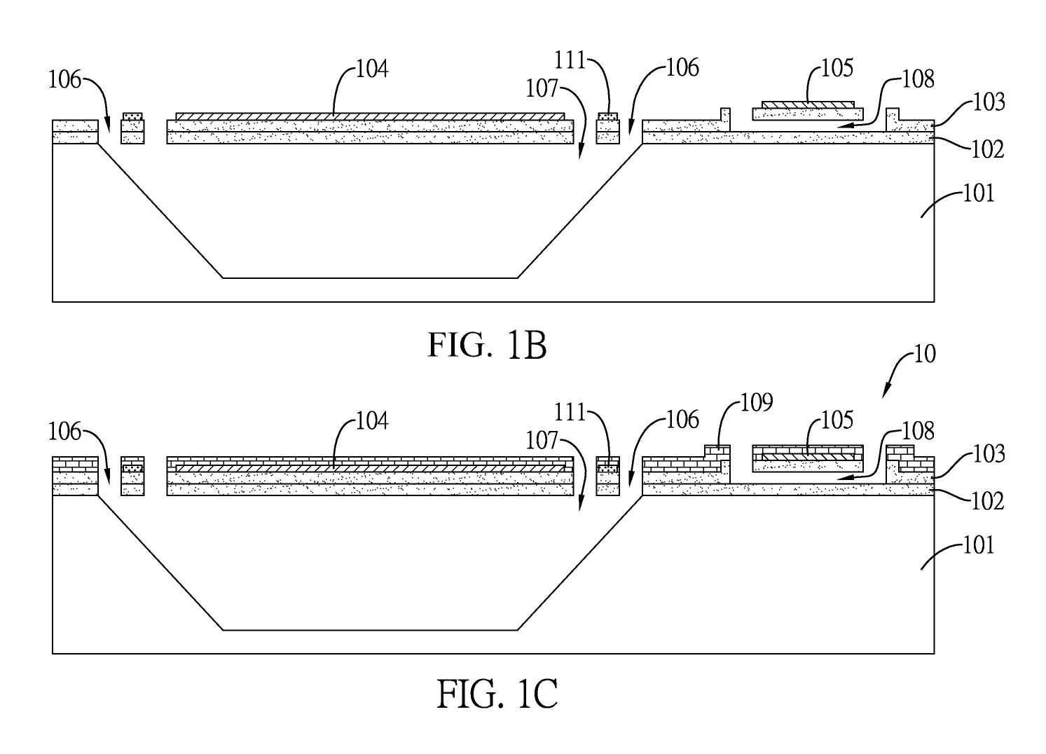

FIG. 1A is a top view of a thermal type vacuum gauge in the present invention. FIG. 1B is a sectional view of the thermal type vacuum gauge in FIG. 1A. As shown in FIG. 1A and FIG. 1B, the thermal type vacuum gauge 10 in the present invention is formed by a substrate 101, a first insulating layer 102, a second insulating layer 103, at least one first sensing resistor 104, at least one second sensing resistor 105.

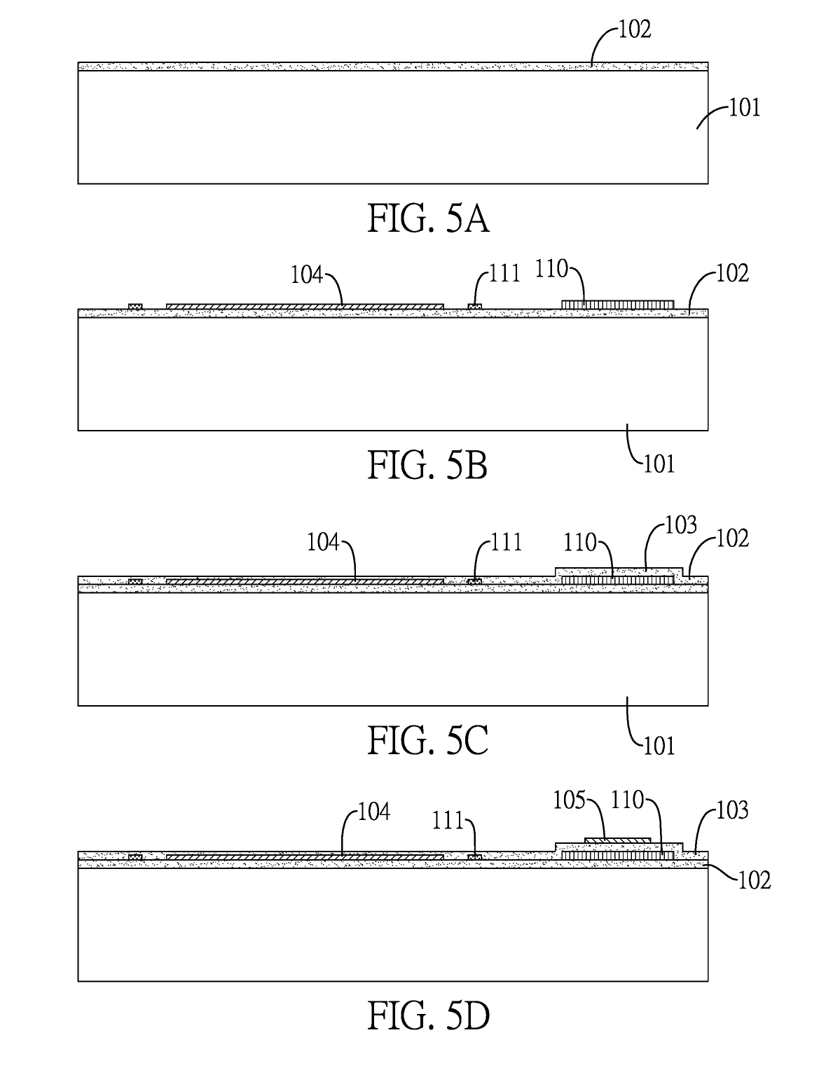

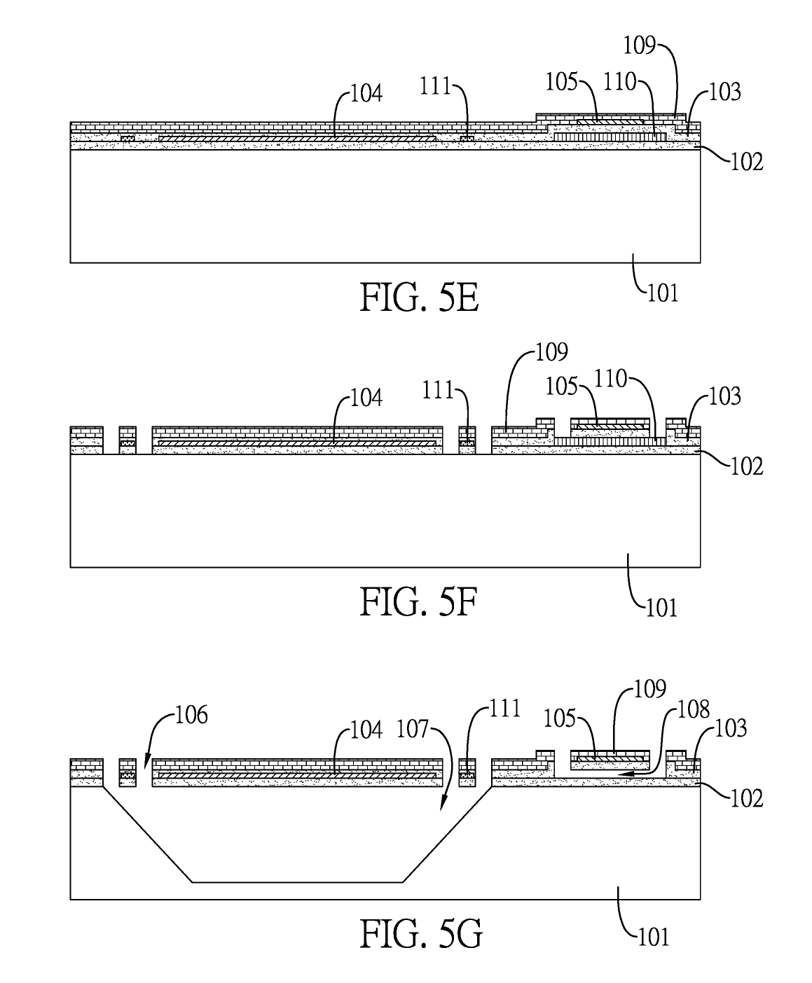

In the present embodiment, the first insulating layer 102 is disposed on the substrate 101. The second insulating layer 103 is disposed on a surface of the first insulating layer 102. The first sensing resistor 104 and the second sensing resistor 105 are formed on a surface of the second insulating layer 103. In a different embodiment, the first sensing resistor 104 may be firstly formed on the surface of the first insulating layer 102 and then the second insulating layer 103 covers the first sensing resistor 104 and the first insulating layer 102. The second sensing resistor 105 is formed above the first insulating layer 102 and/or the second insulating layer 103 (as shown in FIG. 5, the detailed description thereof is disclosed in the following). In a different embodiment, if the first sensing resistor 104 and the second sensing resistor 105 include the same characteristics, such as both of them having positive temperature coefficient of resistance (PTCR) or negative temperature coefficient of resistance (NTCR), the first sensing resistor 104 and the second sensing resistor 105 are all disposed on the surface of the second insulating layer 103. Alternatively, if the first sensing resistor 104 and the second sensing resistor 105 include different characteristics, such as the first sensing resistor 104 having PTCR and the second sensing resistor 105 having NTCR and vice versa, the second insulating layer 103 is disposed between the first sensing resistor 104 and the second sensing resistor 105 so as to isolate the first sensing resistor 104 from the second sensing resistor 105. In addition, in some other embodiments in the present invention, with reference to FIG. 1C, the thermal type vacuum gauge 10 includes a passivation layer 109 and the passivation layer 109 covers the first sensing resistor 104, the second sensing resistor 105, and the second insulating layer 103. The first insulating layer 102 and the second insulating layer 103 are made of at least one dielectric film

The thermal type vacuum gauge 10 in the present invention includes a first floating structure, a second floating structure, a first cavity 107, and a second cavity 108. The first floating structure is formed by the first insulating layer 102, the second insulating layer 103, and the at least one first sensing resistor 104. The second floating structure is formed by the second insulating layer 103 and the at least one second sensing resistor 105. The first floating structure and the second floating structure are supported by the first insulating layer 102 and the second insulating layer 103. The first cavity 107 is located below the first sensing resistor 104. The second cavity 108 is located below the second sensing resistor 105. A depth of the first cavity 107 is deeper than a depth of the second cavity 108.

The thermal type vacuum gauge 10 in the present invention includes a plurality of electrical connecting wires 111 disposed around the first sensing resistor 104 and a plurality of etching holes 106 are respectively formed around the first sensing resistor 104 and the second sensing resistor 105. When the first sensing resistor 104 and the second sensing resistor 105 both include PTCR or NTCR, the first sensing resistor 104 and the second sensing resistor 105 may be made of the same material. Therefore, the first sensing resistor 104 and the second sensing resistor 105 may be formed between the first insulating layer 102 and the second insulating layer 103 at the same time, as the embodiments shown in FIG. 1A and FIG. 1B. When the first sensing resistor 104 and the second sensing resistor 105 include PTCR and NTCR respectively, the first sensing resistor 104 and the second sensing resistor 105 may be made of different materials. Therefore, the first sensing resistor 104 is formed above the first insulating layer 102 firstly, and the second insulating layer 103 is formed above the first sensing resistor 104 and then the second sensing resistor 105 is formed above the second insulating layer 103. The second insulating layer 103 can separate the first sensing resistor 104 from the second sensing resistor 105.

Since the structure of the thermal type vacuum gauge in the present invention includes the first sensing resistor 104 and the second sensing resistor 105, and the first sensing resistor 104 and the second sensing resistor 105 respectively correspond to the first cavity 107 and the second cavity 108 with different sizes, the first sensing resistor 104 and the second sensing resistor 105 respectively include different solid thermal conduction results and gas thermal conduction results. The first sensing resistor 104 corresponding to the larger first cavity 107 includes the lower pressure lower limit and the lower pressure upper limit The second sensing resistor 105 corresponding to the smaller second cavity 108 includes the higher pressure lower limit and the higher pressure lower limit (the reasons as described in prior art). Since the first sensing resistor 104 complements to the second sensing resistor 105, the thermal type vacuum gauge 10 in the present invention includes a wider effective pressure dynamic range.

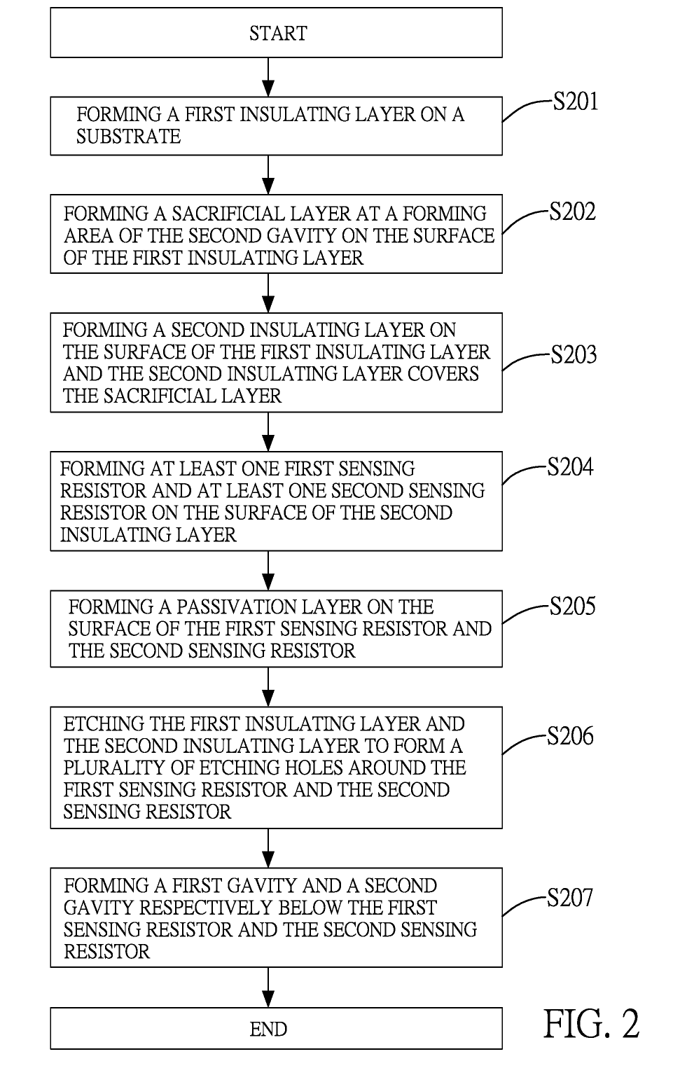

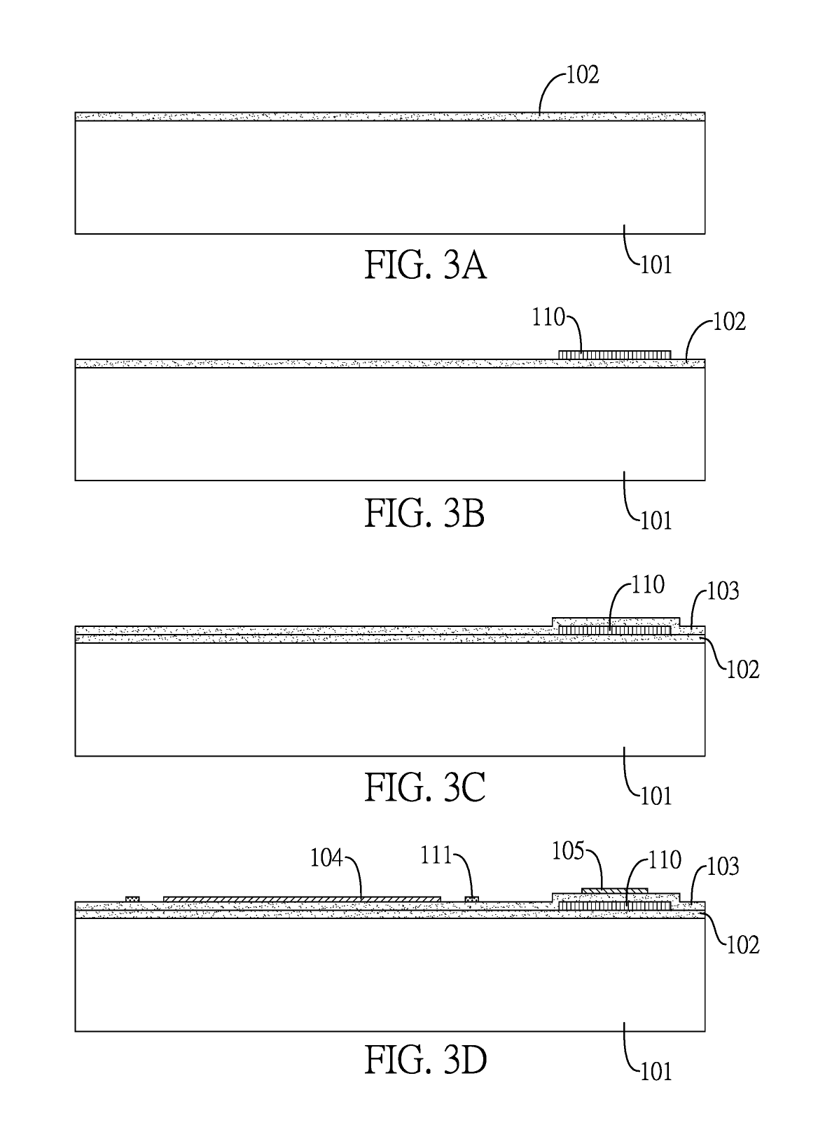

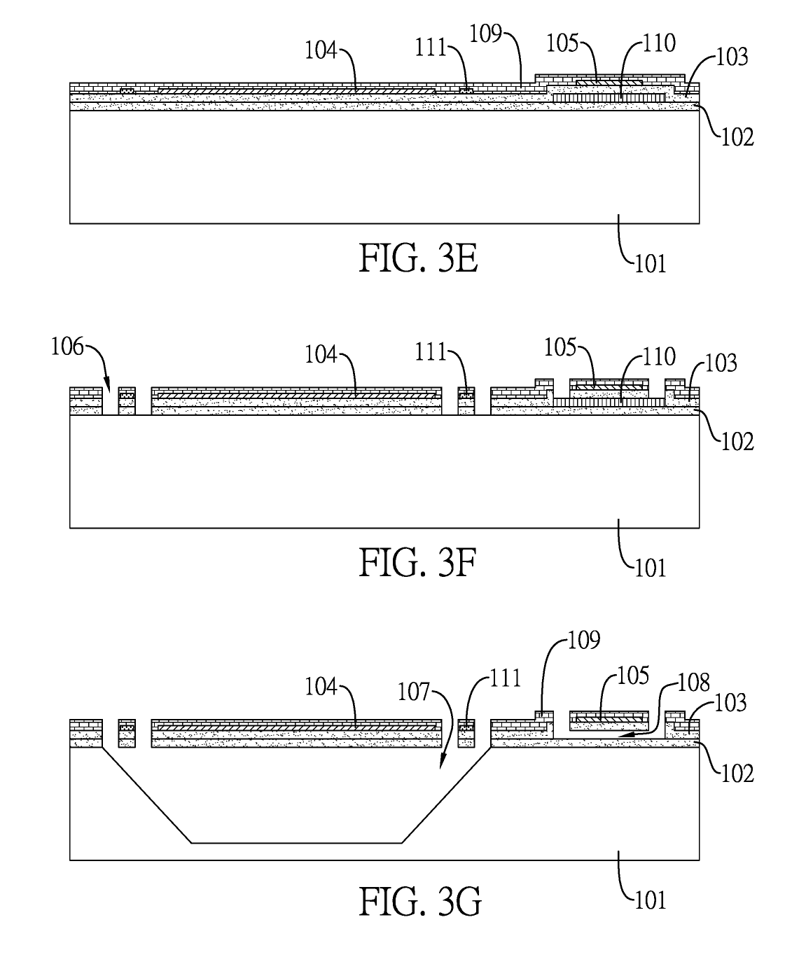

FIG. 2 is a flow chart of the thermal type vacuum gauge in the embodiment of the present invention. As shown in FIG. 2, FIG. 1B and FIG. 3A-FIG. 3G firstly, in step S201, with reference to FIG. 3A, a first insulating layer 102 is formed on a substrate 101. Then, in step S202, with reference to FIG. 3B, a sacrificial layer 110 is formed at a forming area of the second cavity on the surface of the first insulating layer 102. In step S203, with reference to FIG. 3C, a second insulating layer 103 is formed on the surface of the first insulating layer 102 and the second insulating layer 103 covers the sacrificial layer 110. In step S204, with reference to FIG. 3D, at least one first sensing resistor 104 and at least one second sensing resistor 105 are formed on the surface of the second insulating layer 103. The structures of the first sensing resistor 104 and the second sensing resistor 105 are not limited herein. In other words, the shapes of the first sensing resistor 104 and the second sensing resistor 105 are not limited herein and may be straight shapes, arc shapes or curved shapes. In the present embodiment, the first sensing resistor 104 and the second sensing resistor 105 both are PTCR or NTCR, so both of them can be made at the same procedure. In addition, a plurality of electrical connecting wires 111 are formed on second insulating layer 103 at the same time when the first sensing resistor 104 and the second sensing resistor 105 are formed.

Moreover, after the step S204 is finished, in step S205, with reference to FIG. 3E, a passivation layer 109 is formed on the surface of the first sensing resistor 104 and the second sensing resistor 105 and the passivation layer 109 covers the first sensing resistor 104, the second sensing resistor 105, and the electrical connecting wires 111. However, in a different embodiment, the step of forming the passivation layer 109 may not be included in the present invention, and that the passivation layer 109 is included or not is not limited herein. In step S206, with reference to FIG. 3F, the first insulating layer 102 and the second insulating layer 103 are etched to form a plurality of etching holes 106 around the first sensing resistor 104 and the second sensing resistor 105. If the passivation layer 109 is included in the embodiment of the present invention, the passivation layer 109, the first insulating layer 102, and the second insulating layer 103 are etched to form the etching holes 106. Thereafter, in step S207, with reference to FIG. 3G, via the etching holes 106, a first cavity 107 and a second cavity 108 are formed respectively below the first sensing resistor 104 and the second sensing resistor 105. The first cavity 107 is formed by etching the substrate 101 with bulk micromachining technique. The first cavity 107 in the embodiment of the present invention has a trapezoid shape, but the first cavity 107 may have a different shape in a different embodiment and it is not limited herein. In addition, the second cavity is formed by etching the sacrificial layer with surface machining technique. The depth of the first cavity 107 is greater than the depth of the second cavity 108. The bulk machining technique and the surface machining technique are well known for the person with ordinary skill in the art, so the description thereof is omitted herein.

By the aforementioned steps to complete the manufacture process of the thermal type vacuum gauge in the present invention, by comparing to the conventional manufacture process of the thermal type vacuum gauge, without adding too many additional steps, the thermal type vacuum gauge with higher pressure upper limit and lower pressure lower limit can be made.

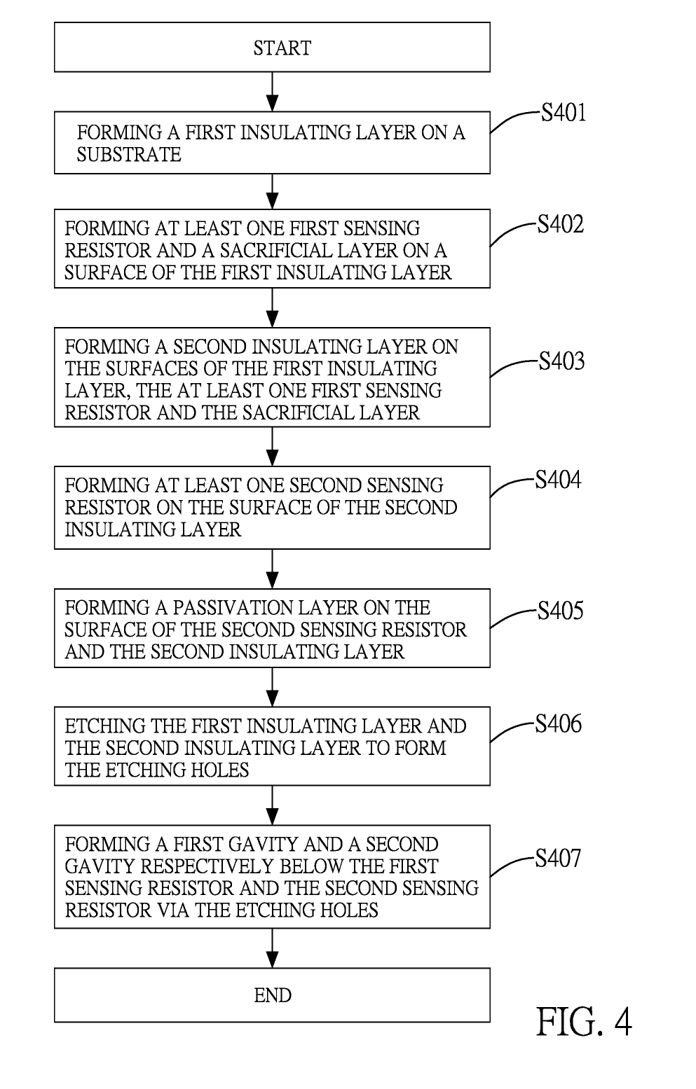

FIG. 4 is a flow chart of the thermal type vacuum gauge in another embodiment of the present invention. As shown in FIG. 4, FIG. 1B and FIG. 5A-FIG. 5G firstly, with reference to FIG. 5A, in step S401, a first insulating layer 102 is formed on a substrate 101. Then, in step S402, with reference to FIG. 5B, at least one first sensing resistor 104 and a sacrificial layer 110 are formed on a surface of the first insulating layer 102. In addition, when the first sensing resistor 104 is formed, a plurality of electrical connecting wires 111 are also formed on the first insulating layer 102. In step S403, with reference to FIG. 5C, a second insulating layer 103 is formed on the surfaces of the first insulating layer 102, the at least one first sensing resistor 104 and the sacrificial layer 110. Therefore, the second insulating layer 103 may cover the first insulating layer 102, the at least one first sensing resistor 104 and the sacrificial layer 110. In step S404, with reference to FIG. 5D, at least one second sensing resistor 105 is formed on the surface of the second insulating layer 103. In this embodiment, the first sensing resistor 104 and the second sensing resistor 105 are PTCR and NTCR respectively, so it is necessary to form the first sensing resistor 104 and the second sensing resistor 105 at different process steps (step S402 and step S404) with different materials.

Moreover, after the step S404 is finished, in step S405, with reference to FIG. 5E, a passivation layer 109 is formed on the surface of the second sensing resistor 105 and the second insulating layer 103, and the passivation layer 109 covers the second sensing resistor 105 and the second insulating layer 103. However, in a different embodiment, the step of forming the passivation layer 109 may not be included in the present invention, and that the passivation layer 109 is included or not is not limited herein. In step S406, with reference to FIG SF, the first insulating layer 102 and the second insulating layer 103 are etched to form a plurality of etching holes 106. When the passivation layer 109 is included in the embodiment, the passivation layer 109, the first insulating layer 102 and the second insulating layer 103 are etched to form a plurality of etching holes 106. Specifically, in step S406, the first insulating layer 102 and the second insulating layer 103 around the at least one first sensing resistor 104 and the at least one second sensing resistor 105 are etched to form the etching holes 106. Thereafter, in step S407, via the etching holes 106, a first cavity 107 and a second cavity 108 are formed respectively below the first sensing resistor 104 and the second sensing resistor 105. The first cavity 107 is formed by etching the substrate 101 via the etching holes 106 in accordance with bulk micromachining technique. The second cavity 108 is formed by etching the sacrificial layer 110 via the etching holes in accordance with surface machining technique and the second cavity 108 is corresponding to the second sensing resistor 105. The depth of the first cavity 107 is different from the depth of the second cavity 108.

The thermal type vacuum gauge 10 in this embodiment also includes a first floating structure, a second floating structure, a first cavity 107, and a second cavity 108. The first floating structure is formed by the first insulating layer 102, the second insulating layer 103, and the at least one first sensing resistor 104. The second floating structure is formed by the second insulating layer 103 and the at least one second sensing resistor 105. The first floating structure and the second floating structure are supported by the first insulating layer 102 and the second insulating layer 103. The first cavity 107 is located below the first sensing resistor 104. The second cavity 108 is located below the second sensing resistor 105. A depth of the first cavity 107 is deeper than a depth of the second cavity 108. The first insulating layer 102 and the second insulating layer 103 shown in FIG. 5A to FIG. 5G are made of at least one dielectric film

By the aforementioned steps, it may also complete the manufacture process of the thermal type vacuum gauge in the present invention and the first sensing resistor 104 and the second sensing resistor 105 in the embodiment are PTCR and NTCR respectively. The first sensing resistor 104 and the second sensing resistor 105 are made by different materials and it is necessary to process them at different manufacture steps. In addition, the thermal type vacuum gauge in the embodiment also includes the higher pressure upper limit and the lower pressure lower limit

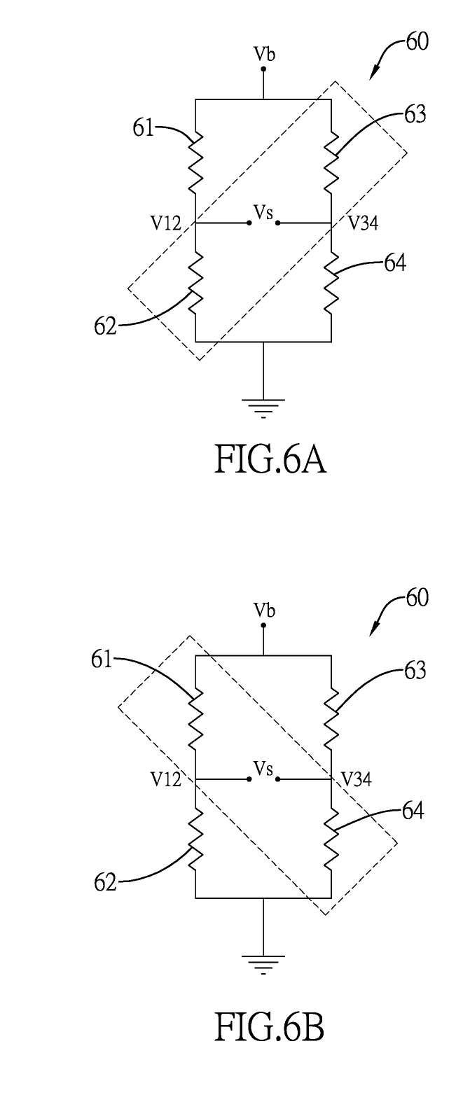

FIG. 6A is a measurement circuit diagram implemented in the thermal type vacuum gauge of the embodiment in FIG. 1A and FIG. 1B. As shown in FIG. 6A, the measurement circuit 50 is preferred to be a Wheatstone Bridge circuit and includes a first resistor 51, a second resistor 52, a third resistor 53 and a fourth resistor 54. When both of the first sensing resistor 104 and the second sensing resistor 105 in FIG. 1A and FIG. 1B having PTCR are implemented in the second resistor 52 and the third resistor 53 of the measurement circuit 50. The first resistor 51 and the second resistor 52 (the first sensing resistor 104) are connected in series between a voltage difference of an operating voltage Vb and a ground point. The third resistor 53 (the second sensing resistor 105) and the fourth resistor 54 are connected in series between the voltage difference of the operating voltage and the ground point and further connected in parallel with the first resistor 51 and the second resistor 52. Equations of the Wheatstone Bridge circuit as the measurement circuit 50 are:

$$Vs = V 34 - V 12 , V 12 = Vb [ \frac{{R}_{2} ( T )}{{R}_{1} + {R}_{2} ( T )} ] , V 34 = Vb [ \frac{{R}_{4}}{{R}_{3} ( T ) + {R}_{4}} ]$$

Resistant values of the first resistor 51, the second resistor 52, the third resistor 53 and the fourth resistor 54 are R₁, R₂(T), R₃(T) and R₄ respectively. Vs is a signal variation value of the measurement circuit. V12 is a node voltage between the first resistor 51 and the second resistor 52 and V34 is the node voltage between the third resistor 53 and the fourth resistor 54. Since both of the second resistor 52 and the third resistor 53 include PTCR, the resistant values of the second resistor 52 and the third resistor 53 become smaller as temperature drops when pressure is increased. The voltage value of the node voltage V34 between the third resistor 53 and the fourth resistor 54 is decreased and the voltage value of the node voltage V12 between the first resistor 51 and the second resistor 52 is decreased. Therefore, the signal variation value Vs of the measurement circuit is substantially increased. Moreover, when the second resistor 52 and the third resistor 53 are the first sensing resistor 104 and the second sensing resistor 105 with NTCR, the signal variation value is a negative value and the effect to increase the signal variation value of the measurement circuit is the same.

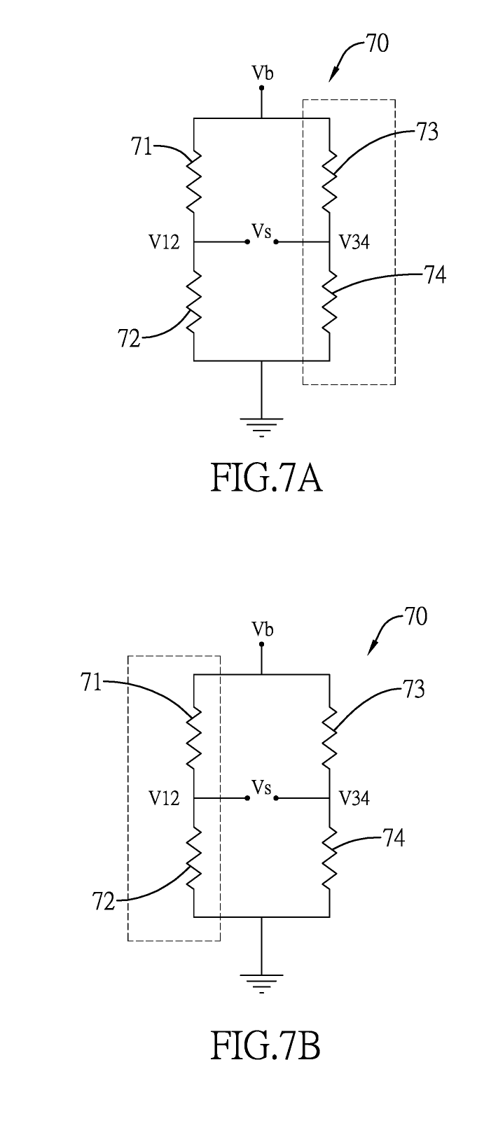

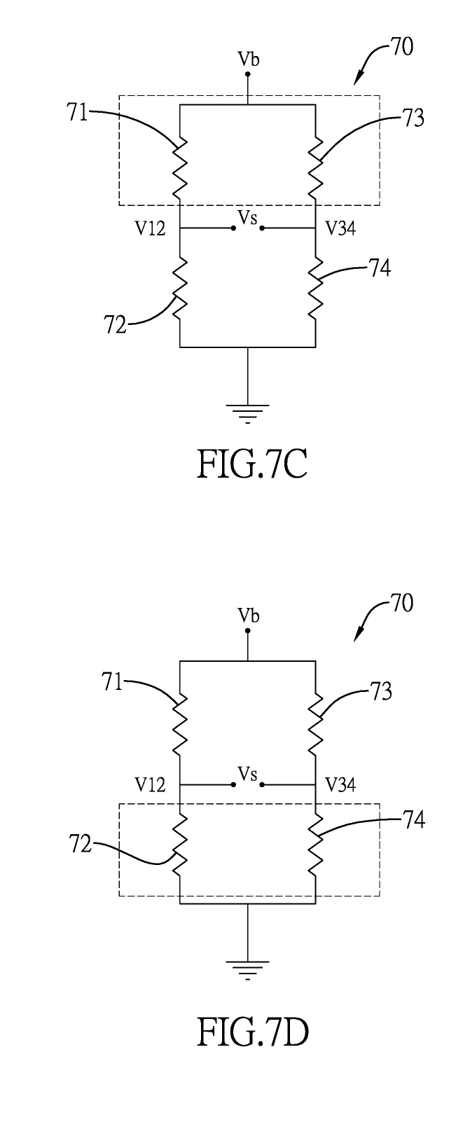

Alternatively, with reference to FIG. 1A, FIG. 1B and FIG. 6B, the first sensing resistor 104 and the second sensing resistor 105 with PTCR are implemented to be the first resistor 51 and the fourth resistor 54 of the measurement circuit 50. The first resistor 51 (the first sensing resistor 104) and the second resistor 52 are connected in series between the voltage difference of the operating voltage Vb and the ground point. The third resistor 53 and the fourth resistor 54 (the second sensing resistor 105) are connected in series between the voltage difference of the operating voltage Vb and the ground point and further connected in parallel with the first resistor 51 and the second resistor 52. Since the first sensing resistor 104 (the first resistor 51) and the second sensing resistor 105 (the fourth resistor 54) include PTCR, the resistance value R1(T) and the R4(T) of the first resistor 53 and the fourth resistor 54 become smaller as the temperature drops when the pressure is increased. The voltage value of the node voltage V34 between the third resistor 53 and the fourth resistor 54 are increased and the voltage value of the node voltage V12 between the first resistor 51 and the second resistor 52 are decreased. Therefore, the signal variation value Vs also has an increasing effect. FIG. 7A-FIG. 7D are circuit diagrams of the measurement circuits implemented in the thermal sensing device in FIG. 1A and FIG. 1B. As shown in FIG. 7A, the measurement circuit 60 is also a Wheatstone Bridge circuit and includes a first resistor 61, a second resistor 62, a third resistor 63 and a fourth resistor 64.

The first resistor 61 and the second resistor 62 are connected in series between the voltage difference of an operating voltage Vb and a ground point. The third resistor 63 and the fourth resistor 64 are connected in series between the voltage difference of the operating voltage and the ground point and further connected in parallel with the first resistor 61 and the second resistor 62.

The first sensing resistor 104 and the second sensing resistor 105 in FIG. 1A and FIG. 1B are respectively implemented to be the third resistor 63 and the fourth resistor 64 in the measurement circuit 60. Equations of the Wheatstone Bridge circuit as the measurement circuit 60 are:

$$Vs = V 34 - V 12 , V 12 = Vb [ \frac{{R}_{2}}{{R}_{1} + {R}_{2}} ] , V 34 = Vb [ \frac{{R}_{4} ( T )}{{R}_{3} ( T ) + {R}_{4} ( T )} ]$$

Resistant values of the first resistor 61, the second resistor 62, the third resistor 63 and the fourth resistor 64 are R₁, R₂, R₃(T) and R₄(T) respectively. The third resistor 63 and the fourth resistor 64 respectively include PTCR and NTCR. The resistant value of the third resistor 63 becomes smaller as the temperature drops when the pressure is increased. The voltage value of the node voltage V34 between the third resistor 63 and the fourth resistor 64 is increased. Therefore, the signal variation value Vs of the measurement circuit is substantially increased.

In addition, in a different embodiment, a different circuit structure in the measurement circuit 60 can achieve the purpose of increasing the signal variation value Vs of the measurement circuit 60, as shown in FIG. 5B - FIG. 5D. With reference to FIG. 7B, the first sensing resistor 104 and the second sensing resistor 105 in FIG. 1A and FIG. 1B are implemented to be the first resistor 61 and the second resistor 62. The first resistor 61 and the second resistor 62 respectively include NTCR and PTCR. With reference to FIG. 7C, the first sensing resistor 104 and the second sensing resistor 105 in FIG. 1A and FIG. 1B are implemented to be the first resistor 61 and the third resistor 63. The first resistor 61 and the third resistor 63 respectively include NTCR and PTCR. With reference to FIG. 7D, the first sensing resistor 104 and the second sensing resistor 105 in FIG. 1A and FIG. 1B are implemented to be the second resistor 62 and the fourth resistor 64. The second resistor 62 and the fourth resistor 64 respectively include PTCR and NTCR.

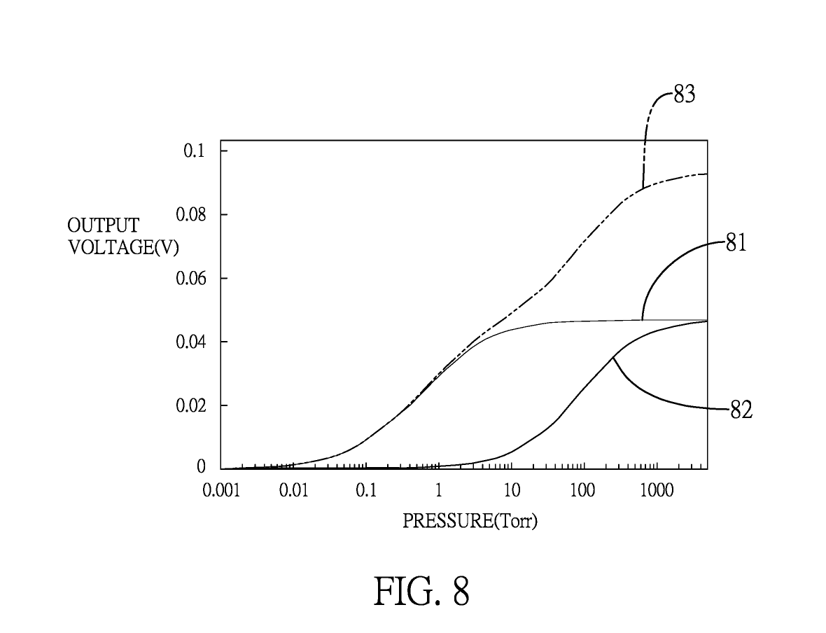

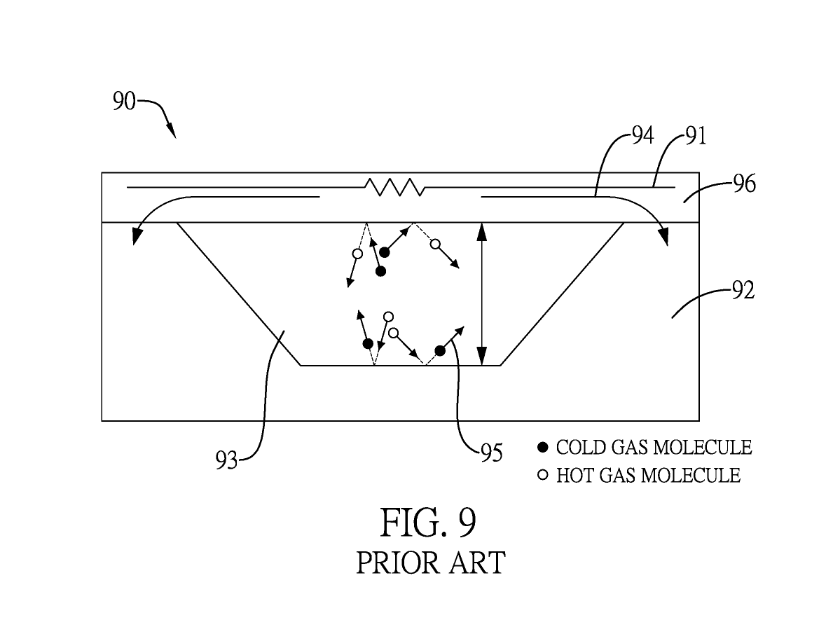

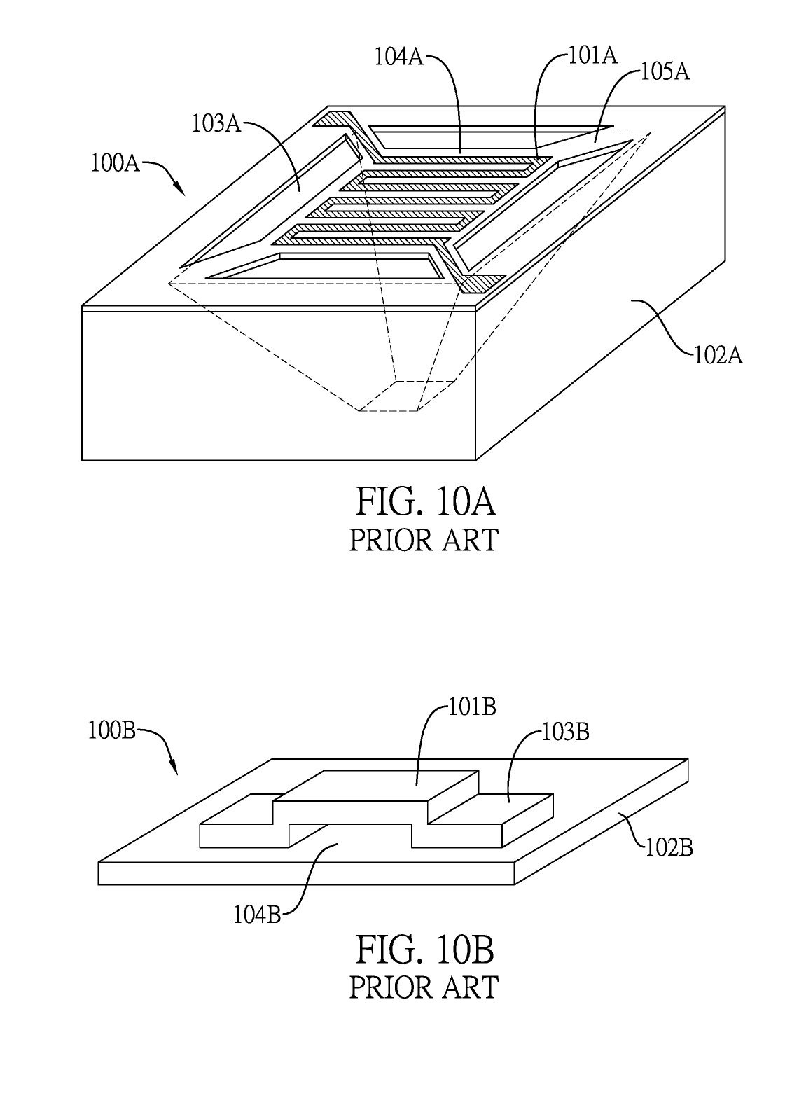

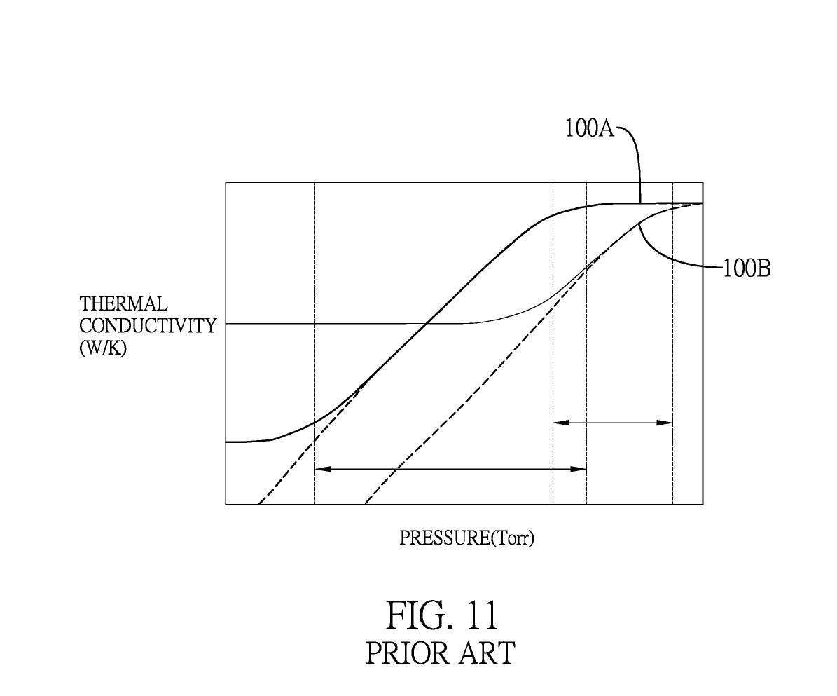

FIG. 8 is a characteristic curve diagram of the thermal type vacuum gauge in the present invention and the conventional thermal type vacuum gauge. As shown in FIG. 8, the effective pressure dynamic ranges of the first thermal type vacuum gauge 71, the second thermal type vacuum gauge 72 and the third thermal type vacuum gauge 73 are compared in the drawing. The conventional first thermal type vacuum gauge 71 includes the lower pressure upper limit and also includes the lower pressure lower limit The conventional second thermal type vacuum gauge 72 includes the higher pressure lower limit and also includes the higher pressure upper limit The third thermal type vacuum gauge is the thermal type vacuum gauge in the present invention and includes the lower pressure upper limit and the higher pressure lower limit It is obvious to see in the drawing that the third thermal type vacuum gauge 73 in the present invention includes a higher effective dynamic range compared to the conventional first thermal type vacuum gauge 71 and the conventional second thermal type vacuum gauge 72.

In summary, since the thermal type vacuum gauge in the present invention includes a wider dynamic range, the thermal type vacuum gauge in the present invention can be implemented in more different fields than the conventional thermal type vacuum gauge. The thermal type vacuum gauge includes a good heat isolation effect without many extra process steps added in the manufacture procedure of the thermal type vacuum gauge of the present invention.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

1. A thermal type vacuum gauge, comprising:
a substrate;
a first insulating layer formed on the substrate;
a second insulating layer formed on the first insulating layer;
at least one first sensing resistor formed above the first insulating layer, each one of the at least one first sensing resistor having a first temperature coefficient of resistance;
at least one second sensing resistor formed above the first insulating layer and separated from the at least one first sensing resistor, each one of the at least one second sensing resistor having a second temperature coefficient of resistance;
a plurality of etching holes formed around the at least one first sensing resistor and the at least one second sensing resistor;
a first floating structure formed by the first insulating layer, the second insulating layer, and the at least one first sensing resistor;
a second floating structure formed by the second insulating layer, and the at least one second sensing resistor; and
a first cavity and a second cavity respectively formed below the first floating structure and the second floating structure, wherein the depth of the first cavity is different from that of the second cavity thereof;
wherein the thermal type vacuum gauge is implemented in a measurement circuit is implemented to have having a first resistor, a second resistor, a third resistor and a fourth resistor, and the at least one first sensing resistor and the at least one second sensing resistor are respectively implemented to be as at least two of the first resistor, the second resistor, the third resistor and the fourth resistor of the measurement circuit.

2. The thermal type vacuum gauge as claimed in claim 1, wherein the measurement circuit is a Wheatstone Bridge circuit, and the first resistor and the second resistor of the measurement circuit are connected in series between a voltage difference of an operating voltage and a ground point, and the third resistor and the fourth resistor are connected in series between the voltage difference of the operating voltage and the ground point, and the first resistor and the second resistor in series are further connected in parallel with the third resistor and the fourth resistor in series.

3. The thermal type vacuum gauge as claimed in claim 2, wherein both the first temperature coefficient of resistance of each one of the at least one first sensing resistor and the second temperature coefficient of resistance of each one of the at least one second sensing resistor are positive temperature coefficient of resistances (PTCR) and the at least one first sensing resistor and the at least one second sensing resistor are implemented respectively to be the second resistor and the third resistor or respectively to be the first resistor and the fourth resistor in the measurement circuit.

4. The thermal type vacuum gauge as claimed in claim 2, wherein both the first temperature coefficient of resistance of each one of the at least one first sensing resistor and the second temperature coefficient of resistance of each one of the at least one second sensing resistor have negative temperature coefficient of resistances (NTCR) and the at least one first sensing resistor and the at least one second sensing resistor are implemented respectively to be the second resistor and the third resistor or respectively to be the first resistor and the fourth resistor in the measurement circuit.

5. The thermal type vacuum gauge as claimed in claim 2, wherein the first temperature coefficient of resistance of each of the at least one first sensing resistor is PTCR or NTCR and the second temperature coefficient of resistance of each of the at least one second sensing resistor is opposite to the first temperature coefficient of resistance, and the at least one first sensing resistor and the at least one second sensing resistor are implemented respectively to be the third resistor and the fourth resistor, the third resistor and the first resistor, the second resistor and the first resistor or the first resistor and the fourth resistor in the measurement circuit.

6. The thermal type vacuum gauge as claimed in claim 1, further comprising a passivation layer formed above the at least one second sensing resistor and the second insulating layer.

7. The thermal type vacuum gauge as claimed in claim 6, further comprising a plurality of electrical connecting wires formed above the second insulating layer and below the passivation layer.

8. The thermal type vacuum gauge as claimed in claim 1, wherein the first insulating layer and the second insulating layer are made of at least one dielectric film.

9. A thermal type vacuum gauge comprising:
a substrate;
a first insulating layer formed on the substrate;
at least one first sensing resistor formed above the first insulating layer, each one of the at least one first sensing resistor having a first temperature coefficient of resistance;
a second insulating layer formed on the at least one first sensing resistor;
at least one second sensing resistor formed on the second insulating layer, each one of the at least one second sensing resistor having a second temperature coefficient of resistance;
a plurality of etching holes formed around the at least one first sensing resistor and the at least one second sensing resistor;
a first floating structure formed by the first insulating layer, the second insulating layer, and the at least one first sensing resistor;
a second floating structure formed by the second insulating layer and the at least one second sensing resistor;
a first cavity and a second cavity respectively formed below the first floating structure and the second floating structure, wherein a depth of the first cavity is different from that of the second cavity thereof;
a passivation layer formed above the at least one second sensing resistor and the second insulating layer; and
a plurality of electrical connecting wires formed above the second insulating layer and below the passivation layer;
wherein a measurement circuit is implemented to have a first resistor, a second resistor, a third resistor and a fourth resistor, and the at least one first sensing resistor and the at least one second sensing resistor are respectively implemented to be as at least two of the first resistor, the second resistor, the third resistor and the fourth resistor of the measurement circuit.

10. The thermal type vacuum gauge as claimed in claim 9, wherein the measurement circuit is a Wheatstone Bridge circuit, and the first resistor and the second resistor of the measurement circuit are connected in series between a voltage difference of an operating voltage and a ground point, and the third resistor and the fourth resistor are connected in series between the voltage difference of the operating voltage and the ground point, and the first resistor and the second resistor in series are further connected in parallel with the third resistor and the fourth resistor in series.

11. The thermal type vacuum gauge as claimed in claim 10, wherein both the first temperature coefficient of resistance of each one of the at least one first sensing resistor and the second temperature coefficient of resistance of each one of the at least one second sensing resistor are positive temperature coefficient of resistances (PTCR) and the at least one first sensing resistor and the at least one second sensing resistor are implemented respectively to be the second resistor and the third resistor or respectively to be the first resistor and the fourth resistor in the measurement circuit.

12. The thermal type vacuum gauge as claimed in claim 10, wherein both the first temperature coefficient of resistance of each one of the at least one first sensing resistor and the second temperature coefficient of resistance of each one of the at least one second sensing resistor are negative temperature coefficient of resistances (NTCR) and the at least one first sensing resistor and the at least one second sensing resistor are implemented respectively to be the second resistor and the third resistor or respectively to be the first resistor and the fourth resistor in the measurement circuit.

13. The thermal type vacuum gauge as claimed in claim 10, wherein the first temperature coefficient of resistance of each of the at least one first sensing resistor is PTCR or NTCR and the second temperature coefficient of resistance of each of the at least one second sensing resistor is opposite to the first temperature coefficient of resistance, and the at least one first sensing resistor and the at least one second sensing resistor are implemented respectively to be the third resistor and the fourth resistor, the third resistor and the first resistor, the second resistor and the first resistor or the first resistor and the fourth resistor in the measurement circuit.

14. The thermal type vacuum gauge as claimed in claim 9, wherein the first insulating layer and the second insulating layer are made of at least one dielectric film.
